(19) United States
(12) Patent Application Publication
(10) Pub. No.: US 2010/0099015 A1
(43) Pub. Date: Apr. 22, 2010

(54) POWER SUPPLY APPARATUS FOR A VEHICLE

(76) Inventor: Toshiyuki Kawai, Toyohashi-shi (JP)

Correspondence Address: KENYON & KENYON LLP, 1500 K STREET N.W., SUITE 700, WASHINGTON, DC, 20005, US

(21) Appl. No.: 12/528,650

(22) PCT Filed: Mar. 4, 2008
(86) PCT No.: PCT/IB08/00479

§ 371 Date: Aug. 26, 2009

(30) Foreign Application Priority Data
Mar. 30, 2007 (JP) 2007-090150

(51) Int. Cl. H01M 10/50

(52) U.S. Cl. 429/62; 429/120

(57) ABSTRACT

A power supply apparatus in which a power supply body and coolant that cools the power supply body are housed in a power supply case, and in which the power supply case contacts a heat transmitting member, includes a first housing portion that is within the power supply case and houses the power supply body; a second housing portion that is within the power supply case and positioned on the heat transmitting member side of the first housing portion; a dividing plate that allows the coolant to move between the first housing portion and the second housing portion; and circulating means for circulating the coolant between the first housing portion and the second housing portion.

### BACKGROUND OF THE INVENTION

1. Field of the Invention

The invention relates to a power supply apparatus that cools a power supply for driving, or an auxiliary power supply of, a hybrid vehicle or an electric vehicle following an exothermic reaction that occurs during charging or discharging of the power supply while driving.

2. Description of the Related Art

Japanese Patent Application Publication No. 2005-19134 (JP-A-2005-19134) describes a power supply apparatus in which an assembled battery is housed in an inner case, and a space for coolant is formed between this inner case and an outer case. The outer case is covered with a battery case protective member which is attached to a portion that is well ventilated such as a floor panel or the overall vehicle body.

A reserve tank that contains coolant is provided outside the outer tank. The reserve tank is connected to the coolant space such that coolant is able to flow between the two. When the assembled battery needs to be cooled, coolant from the reserve tank is supplied to the coolant space and heat exchange takes place between the assembled battery and the coolant via the entire inner case. The heat absorbed by the coolant from cooling the assembled battery is then dissipated to the floor panel or the like via the outer case and the battery case protective member.

On the other hand, when the temperature of the assembled battery is low, coolant in the coolant space returns to the reserve tank. Accordingly, a layer of air that acts as a heat insulating layer forms in the coolant space, which prevents the assembled battery from being cooled by cold air outside the vehicle, as well as prevents the heat of the assembled battery from being dissipated from the floor panel.

However, with the foregoing structure, the coolant space must be formed between the inner case and the outer case, the reserve tank must be arranged outside the battery case, and a pump must be provided to move the coolant between the coolant space and the reserve tank. As a result, the structure of the power supply apparatus is complicated and unable to be made small.

Also, heat exchange between the assembled battery and the coolant takes place via the inner case so there is a possibility that cooling will be insufficient. In particular, when the assembled battery is made smaller, the temperature of the heat generated by the assembled battery is higher so cooling via the inner case alone may be insufficient.

### SUMMARY OF THE INVENTION

This invention thus provides a power supply apparatus which is able to keep a power supply body at an appropriate temperature by means of a. simple structure.

A first aspect of the invention relates to a power supply apparatus in which a power supply body and coolant that cools the power supply body are housed in a power supply case that contacts a heat transmitting member. This power supply apparatus includes a first housing portion that is within the power supply case and houses the power supply body; a second housing portion that is within the power supply case and positioned on the heat transmitting member side of the first housing portion; a dividing plate that allows the coolant to move between the first housing portion and the second housing portion; and circulating means for circulating the coolant between the first housing portion and the second housing portion.

In this aspect, a coolant passage hole through which the coolant passes between the first housing portion and the second housing portion may be formed in the dividing plate, or a gap through which the coolant passes between the first housing portion and the second housing portion may be formed in the dividing plate. Also, the circulating means may be provided in the second housing portion.

In the foregoing structure, a position in which the coolant passage hole is formed may be determined according to a distribution of heat generated by the power supply body.

The power supply apparatus of the foregoing structure may also include first temperature detecting means for detecting a temperature of coolant in the first housing portion; second temperature detecting means for detecting a temperature of coolant in the second housing portion; and controlling means for controlling a circulating operation of the circulating means based on detection results from the first temperature detecting means and the second temperature detecting means. Further, the controlling means may prohibit the circulating operation of the circulating means when a second detected temperature from the second temperature detecting means is higher than a first detected temperature from the first temperature detecting means.

In the foregoing structure, the controlling means may operate the circulating means when the first detected temperature is within a predetermined temperature range.

In the foregoing structure, the power supply body may be fixed to an upper wall portion of the power supply case, and the dividing plate may be arranged below the power supply body.

In the foregoing structure, the dividing plate may have a thermal conductivity that is lower than the thermal conductivity of the coolant. Also, a plurality of cooling fins may be provided on an outer wall surface of the power supply case. An example of the heat transmitting member is the body (e.g., the floor panel) of a vehicle.

In the foregoing structure, the dividing plate may be provided parallel to a surface of the power supply case which contacts the heat transmitting member.

In the foregoing structure, the circulating means may be one of a fin and a pump which rotates when driven by a motor.

Further, the power supply apparatus of the foregoing structure may be mounted in a vehicle.

Also, a second aspect of the invention relates to a power supply apparatus in which a power supply body and coolant that cools the power supply body are housed in a power supply case that contacts a heat transmitting member. This power supply apparatus includes a first housing portion that is within the power supply case and houses the power supply body; a second housing portion that is within the power supply case and positioned on the heat transmitting member side of the first housing portion; and a circulating passage which is provided outside the power supply case and through which the coolant circulates between the first housing portion and the second housing portion.

According to the foregoing aspects and structures, a simple structure in which a dividing plate is arranged inside a power supply case makes it possible to inhibit coolant that is inside the first housing portion from flowing into the second housing portion, thereby inhibiting the heat of the power supply body from being dissipated from the heat transmitting member. Also, when the power supply body needs to be cooled, the coolant inside the first housing portion can be quickly cooled by moving coolant between the first and second housing portions using the circulating means.

In the second aspect, the power supply apparatus may also include a dividing plate that isolates the coolant in the first housing portion from the coolant in the second housing portion within the power supply case.

In the foregoing structure, the power supply apparatus may also include circulating means for circulating the coolant between the first housing portion and the second housing portion.

In the foregoing structure, the circulating means may be a pump.

In the foregoing structure, the circulating passage may be formed in plurality, and the circulating means may be provided in any one of the plurality of circulating passages.

In the foregoing structure, the circulating passage may also have a radiator.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a plan view of a power supply apparatus according to a first example embodiment of the invention;

FIG. 2A is a plan view of a dividing plate in the first example embodiment;

FIG. 2B is a plan view of a dividing plate according to a first modified example of the first example embodiment;

FIG. 2C is a plan view of a dividing plate according to a second modified example of the first example embodiment;

FIG. 3 is a block diagram of the structure used for driving a circulating fin in the first example embodiment;

FIG. 4 is a flowchart illustrating a method for driving the circulating fin in the first example embodiment;

FIG. 5 is a plan view of a power supply apparatus according to a third modified example of the first example embodiment, in which the arrangement of power supply apparatus has been modified;

FIG. 6 is a plan view of a power supply apparatus according to a fourth modified example of the first example embodiment, in which the circulating means has been modified;

FIG. 7 is a plan view of a power supply apparatus according to a second example embodiment of the invention;

FIG. 8 is a flowchart illustrating a method for driving a circulation pump; and

FIG. 9 is a correlation diagram showing the relationship between battery output and battery temperature.

### DETAILED DESCRIPTION OF THE EMBODIMENTS

Hereinafter, a first example embodiment of the invention will be described.

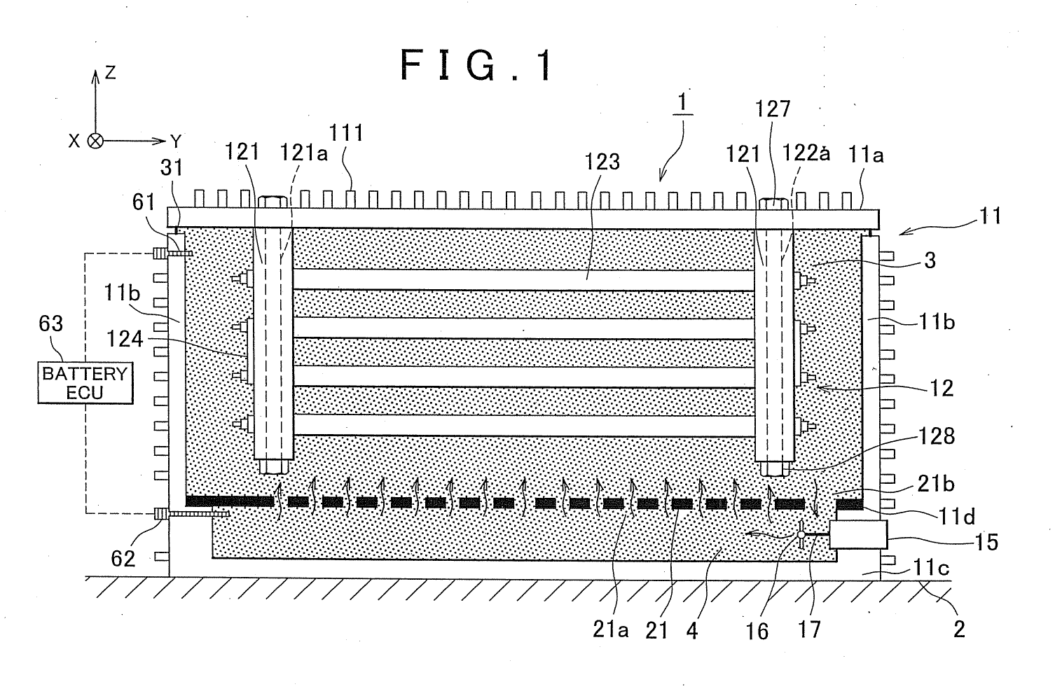

First, the general structure of a power supply apparatus 1 will be described with reference to FIG. 1 which is a plan view in the longitudinal direction of the power supply apparatus 1. The power supply apparatus 1 is formed by an assembled battery (power supply body) 12 housed in a battery case 11 that is filled with coolant, and is used as a power supply for driving, or an auxiliary power supply of, an electric vehicle or a hybrid vehicle or the like.

The assembled battery 12 generates heat at times such as when charging and discharging. If the temperature of that heat becomes excessively high, performance of the battery declines. Therefore, the heat generated by the assembled battery 12 is dissipated outside the vehicle by having the power supply apparatus 1 contacting a floor panel 2 which serves as a heat transmitting member.

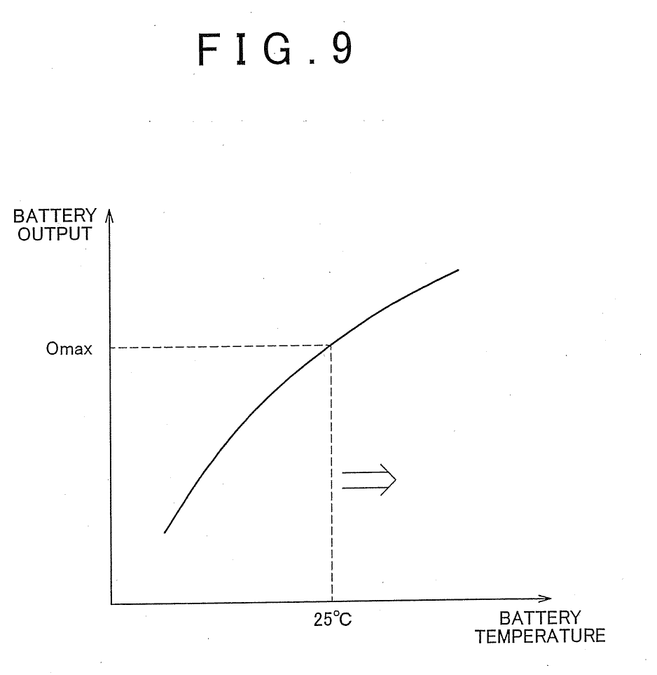

FIG. 9 shows the relationship between battery temperature and battery output of the assembled battery. Incidentally, the assembled battery is formed a plurality of cylindrical cells (such as lithium cells) provided in an array. As shown in the drawing, there is a correlative relationship between the battery output and the battery temperature in which the battery output increases as the battery temperature rises.

Oₘₐₓ in the drawing denotes the output of the assembled battery that is necessary to obtain the maximum output value of the vehicle. In order to obtain a battery output value equal to or greater than Oₘₐₓ, the temperature of the assembled battery must be raised to at least 25° C. Therefore, when the ambient air around the vehicle is cold, it is necessary to inhibit the low temperature of the cold air from reaching the assembled battery through the floor panel 2.

Therefore, as shown in FIG. 1, a dividing plate 21 is arranged in the battery case 11 such that a battery housing portion (i.e., a first housing portion) 3 and a circulating mechanism housing portion (i.e., a second housing portion) 4 are formed. The battery housing portion 3 houses the assembled battery 12 above the dividing plate 21. The circulating mechanism housing portion 4 is formed below the battery housing portion 3 and houses a circulating fin (i.e., circulating means) 16. The dividing plate 21 is preferably mounted parallel to the surface of the battery case which contacts the heat transmitting member. This dividing plate 21 suppresses natural convention of the coolant between the battery housing portion 3 and the circulating mechanism housing portion 4, thereby enabling the temperature of the assembled battery 12 to be kept constant or increased.

On the other hand, because battery deterioration progresses when the maximum temperature of the assembled battery 12 exceeds 70° C., coolant must be circulated to suppress a variation in the temperature distribution of the coolant, as well as to reduce the maximum temperature.

Therefore, in this example embodiment, a plurality of coolant passage holes 21a are formed in the dividing plate 21. When the assembled battery 12 needs to be cooled, the circulating fin 16 is rotated such that coolant moves through the coolant passage holes 21a from the circulating mechanism housing portion 4 to the battery housing portion 3. As a result, coolant in the battery housing portion 3 that has been cooled by having dissipated its heat to outside the vehicle through the floor panel 21 can be supplied to the battery housing portion 3, thereby cooling the assembled battery 12.

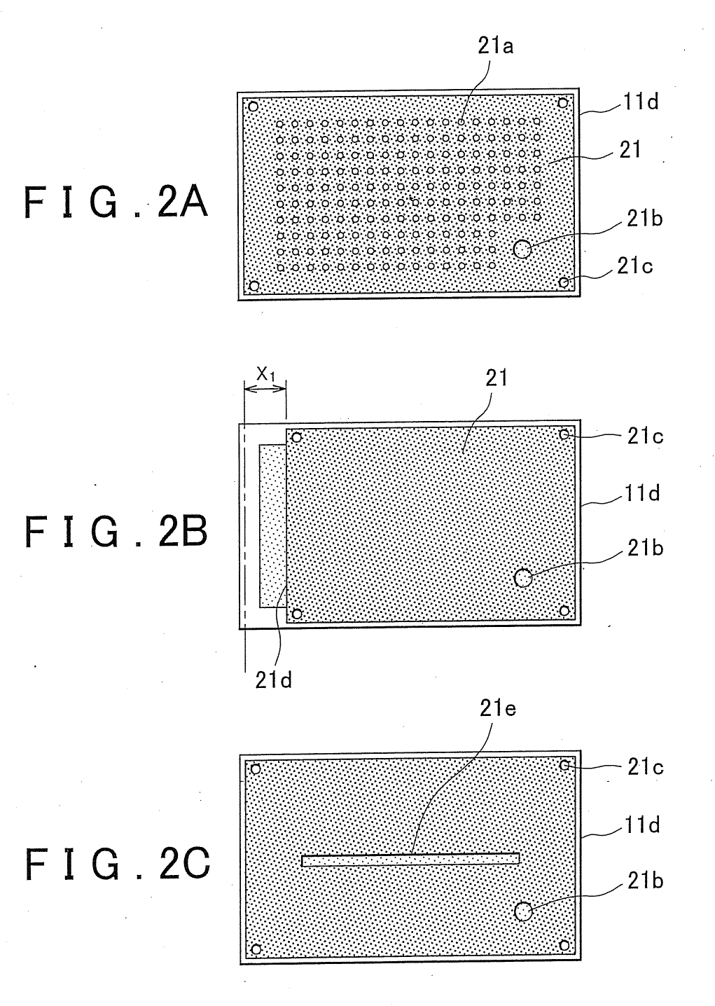

Next, the structure of the power supply apparatus 1 of this example embodiment will be described in detail with reference to FIGS. 1 and 2A. The assembled battery 12 is formed by arranging a plurality of cylindrical cells 123 parallel to one another in between a pair of support plates 121 and 122. In this example embodiment, the cylindrical cells 123 are lithium-ion batteries that are connected in series via a bus bar 124. Incidentally, the cylindrical cells 123 may also be nickel-metal-hydride batteries. Further, square cells may be used instead of cylindrical cells.

The support plates 121 and 122 are formed with insertion hole portions 121a and 122a extending in the vertical direction. Into these insertion hole portions 121a and 122a are inserted assembled battery fixing bolts (i.e., fixing means) 127 that extend from the outside of the battery case 11 through a case upper wall portion 11a.

A lower end portion of each assembled battery fixing bolt 127 protrudes from a lower end surface of the support plates 121 and 122, where it screws into an assembled battery fixing nut 128, thus fixing the assembled battery 12 to the case upper wall portion 11a of the battery case 11.

The coolant in the battery case 11 is a material which has high specific heat, good heat conductivity, and a high boiling point, will not corrode the battery case 11 or the assembled battery 12, and is resistant to thermal decomposition, air oxidation, and electrolysis, and the like. Moreover, an electrically insulating liquid is preferably used to prevent a short between electrode terminals.

A fluorine-containing inert liquid, for example, may be used as the coolant. Examples of a fluorinated inert fluid include Fluorinert™, Novec™ HFE (hydrofluoroether), or Novec™ 1230 from 3M Corporation. Alternatively, a liquid other than fluorinated inert fluid (such as silicon oil) may also be used.

A case side wall portion 11b and a case lower wall portion 11c of the battery case 11 are integrally formed. A plate supporting portion 11d for supporting the dividing plate 21 is provided on an inside wall portion of the case side wall portion 11b. This plate supporting portion 11d is formed by a portion of the case side wall portion 11b that protrudes toward the inside of the battery case 11.

The case upper wall portion 11a is formed separately from the case side wall portion 11b and the case lower wall portion 11c, and a seal member 31 is interposed between the case upper wall portion 11a and the case side wall portion 11b. Interposing this seal member 31 between the case upper wall portion 11a and the case side wall portion 11b in this way prevents the coolant from leaking out of the battery case 11.

Two temperature sensors are provided on the case side wall portion 11b, i.e., a first temperature sensor 61 that extends into the coolant contained in the battery housing portion 3, and a second temperature sensor 62 that extends into the coolant contained inside the circulating mechanism housing portion 4.

These first and second temperature sensors 61 and 62 are electrically connected to a battery ECU (i.e., controlling means) 63. This battery ECU 63 outputs a drive signal for driving the circulating fin 16 when the temperature of the coolant inside the battery housing portion 3 is higher than the temperature of the coolant in the circulating mechanism housing portion 4 by a predetermined temperature or greater, based on the temperature information output from the first and second temperature sensors 61 and 62. The method of driving the circulating fin 16 will be described later.

Also, a magnetic motor 15 for driving the circulating fin 16 is provided on the case side wall portion 11b of the circulating mechanism housing portion 4. The magnetic motor 15 drives a rotating shaft 17 of the circulating fin 16 by magnetic force from outside the battery case 11. Using this magnetic motor 15, coolant circulates while being sealed inside the battery case 11.

Also, many cooling fins 111 are formed on the outer peripheral surfaces of the case upper wall portion 11a and the case side wall portion 11b, which increases the contact area between the power supply apparatus 1 and the outside air, thereby promoting dissipation of heat from the power supply apparatus 1.

The case lower wall portion 11c contacts the floor panel 2 which serves as a heat transmitting member. The power supply apparatus 1 is fixed to the floor panel 2 by fastening a fastening member, not shown, to a flange formed, on an outer wall portion of the case side wall portion 11b.

The battery case 11 may be made of metal material such as iron or copper which conducts heat well.

The many coolant passage holes 21a are formed in the shape of a matrix in the dividing plate 21. In this example embodiment, the radius and pitch of the coolant passage holes 21a are set to inhibit coolant that heats up due to the assembled battery 12 cooling and circulates naturally (i.e., natural convention), from flowing into the circulating mechanism housing portion 4, while allowing coolant that is forced to circulate (i.e., forced convention) by the circulating operation of the circulating fin 16 to flow into the battery housing portion 3. More specifically, the radius and pitch of the coolant passage holes 21a can be set as appropriate according to the circulating ability and the like of the circulating fin 16.

Also, a coolant drawing hole 21b for drawing coolant from inside the battery housing portion 3 into the circulating mechanism housing portion 4 is formed in a position in the dividing plate 21 that corresponds to the rotating shaft 17 of the circulating fin 16. This coolant drawing hole 21b has a larger radius than the coolant passage holes 21a.

The dividing plate 21 may be made of resin or glass that has a lower thermal conductivity than the coolant does. Incidentally, when glass is used, it is necessary to ensure that it is strong so that it does not crack or break from vibrations from the vehicle.

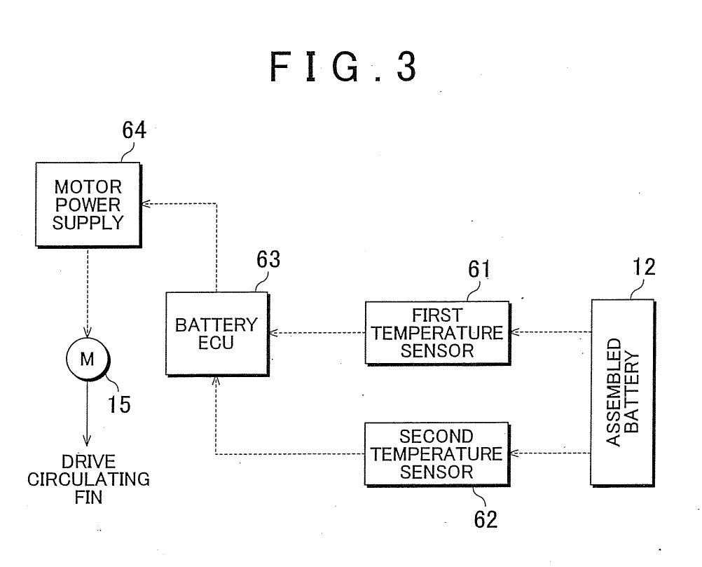

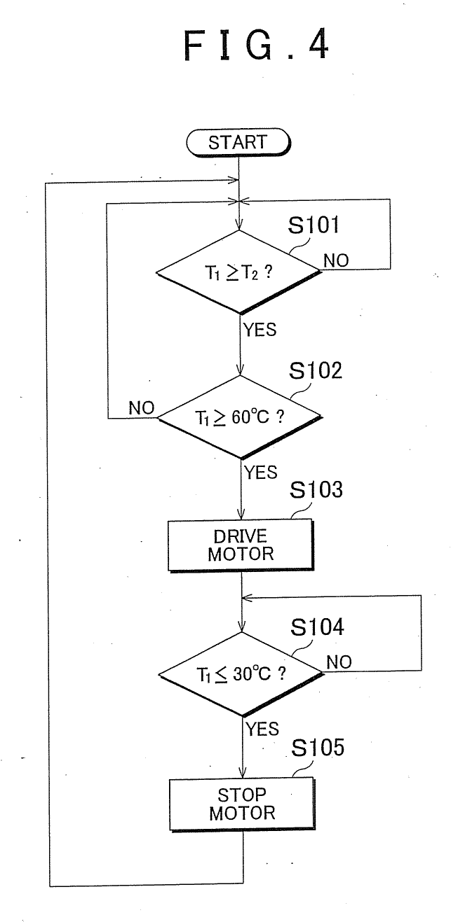

Next, the method of driving the motor 15 and the circulating operation by the circulating fin 16 will be described with reference to FIGS. 1, 3, and 4. Here, FIG. 3 is a block diagram of the structure used for driving a circulating the motor 15, and FIG. 4 is a flowchart illustrating a method for driving the motor 15. As shown in FIG. 3, the battery ECU 63 is electrically connected to a motor power supply 64 and controls it so as to turn it on or off. Incidentally, the motor power supply 64 is initially set to off.

First, the battery ECU 63 compares a temperature T1 of the coolant inside the battery housing portion 3 with a temperature T2 of the coolant inside the circulating mechanism housing portion 4 based on temperature information output from the first and second temperature sensors 61 and 62 (step S101).

If it is determined that T1 is equal to or greater than T2 (i.e., T1≧T2), then the process proceeds on to step S102 where the battery ECU 22 determines whether T1 is equal to or greater than 60° C. (i.e., T1≧60° C.). If the battery ECU 63 determines that T1 is equal to or greater than 60° C. (i.e., YES in step S102), then it turns the motor power supply 64 on and drives the circulating fin 16 (step S103).

When the battery ECU 64 drives the circulating fin 16, coolant that is inside the battery housing portion 3 is drawn into the circulating mechanism housing portion 4 through the coolant drawing hole 21b. As the coolant flows through the circulating mechanism housing portion 4, it contacts the case lower wall portion 11c and cools as a result. This cooled coolant then flows back into the battery housing portion 3 through the coolant passage holes 21a by the circulating action of the circulating fin 16.

As a result, the temperature of the coolant inside the battery housing portion 3 drops, thus enabling the assembled battery 12 to be protected from degradation.

Also, by forcing the coolant to flow into the battery housing portion 3, the coolant is circulated (i.e., agitated), which enables a variation in the temperature to be suppressed. This in turn increases the life of the assembled battery 12.

The reason for making T1≧60° C. a condition for driving the circulating fin 16 here is because the proper temperature at which a lithium-ion battery is used is between 25° C. and 70° C. so it is necessary to control the temperature of the coolant so that it does not exceed 70° C. However, this conditional temperature is not limited to 60° C. That is, when a different type of battery is used, the temperature may be changed as appropriate according to the proper temperature of that battery.

If it is determined in step S102 that T1 is less than 60° C., the process returns to step S101 and the battery ECU 63 keeps the motor supply source 64 off to prohibit the circulating operation by the circulating fin 16. If, on the other hand, T1 is equal to or greater than T2 (i.e., T1≧T2) but less than 60° C. (i.e., T1<60° C.), the temperature of the cooling within the circulating mechanism housing portion 4 may drop excessively from cold air outside the vehicle. If the circulating fin 16 is driven in this case, the temperature of the coolant within the battery housing portion 3 may drop even further and sufficient battery output may not be able to be obtained.

Therefore, if it is determined in step S102 that T1 is less than 60° C. (i.e., T1<60° C.), the battery ECU 63 prohibits the circulating operation by the circulating fin 16. As a result, the temperature of the assembled battery 12 can be maintained or increased.

Also, the dividing plate 21 is formed of material with a lower thermal conductivity than the coolant so the heat of the coolant in the battery housing portion 3 is prevented from dissipating to the circulating mechanism housing portion 4 through the dividing plate 21.

When the battery ECU 63 starts the circulating operation with the circulating fin 16 in step S103, the battery ECU 63 determines whether T1 is equal to or less than 30° C. (i.e., whether T1≦30° C.), that is, whether the temperature of the coolant in the battery housing portion 3 has dropped to 30° C. or below (step S104).

If it is determined in step S104 that T1 is equal to or less than 30° C. (i.e., T1≦30° C.), the process proceeds on to step S105 where the battery ECU 63 switches off the motor power supply 64, thereby prohibiting the circulating operation by the circulating fin 16.

If it is determined in step S104 that T1 is greater than 30° C. (i.e., T1>30° C.), the battery ECU 63 continues the circulating operation by the circulating fin 16.

The reason for making T1≦30° C. a condition for stopping the circulating fin 16 here is because the proper temperature at which a lithium-ion battery is used is between 25° C. and 70° C. so it is necessary to control the temperature of the coolant so that it does not fall below 25° C. However, this conditional temperature is not limited to 30° C. That is, when a different type of battery is used, the temperature may be changed as appropriate according to the proper temperature of that battery.

If it is determined in step S101 that T2 is greater than T1 (i.e., T2>T1), i.e., if the temperature of the coolant in the, circulating mechanism housing portion 4 is higher than the temperature of the coolant in the battery housing portion 3, the battery ECU 63 keeps the motor power supply 64 off, thus prohibiting the circulating operation by the circulating fin 16.

If it is determined that the T2 is greater than T1 (i.e., T2>T1), it means that the temperature of the floor panel 2 is high (which may occur when the vehicle is parked in a high-temperature environment with the engine stopped, for example). Therefore, if coolant from the circulating mechanism housing portion 4 is circulated into the battery housing portion 3 at this time, the temperature of the assembled battery 12 may become excessively high.

In this way, if the temperature of the floor panel 2 is high, the battery ECU 63 prohibits the circulating operation by the circulating fin 16 and suppresses circulation of the coolant from the circulating mechanism housing portion 4 into the battery housing portion 3 by the dividing plate 21, thereby protecting the assembled battery 12 from degradation.

Next, first and second modified examples of the first example embodiment will be described. FIGS. 2B and 2C show first and second modified examples, respectively, of the dividing plate 21 of the first example embodiment. In the drawings, like reference numerals are used to denote parts having the same function.

The dashed line in FIG. 2B shows the end portion of the dividing plate 21 of the first example embodiment. The dividing plate 21 in FIG. 2B is shorter than the dividing plate 21 in the first example embodiment by an amount X₁ in the X direction. Accordingly, a gap 21d can be formed between the case side wall portion 11b and the end portion of the dividing plate 21 to allow the coolant to move between the battery housing portion 3 and the circulating mechanism housing portion 4. The coolant that has flowed from the circulating mechanism housing portion 4 into the battery housing portion 3 through the gap 21d moves along the case side wall portion 11b so the coolant near the inside wall portion of the battery case 11 is able to be reliably circulated (i.e., agitated).

In contrast, a single slit 21e that extends in the X direction is formed in the dividing plate 21 in FIG. 2C. This slit 21e allows the coolant to move between the battery housing portion 3 and the circulating mechanism housing portion 4.

Furthermore, in the first example embodiment, the density with which the coolant passage holes 21a are formed may be set according to the heat distribution of the assembled battery 12. For example, the density with which the coolant passage holes 21a are formed directly below the cylindrical cells 123 which generate a large amount of heat can be made greater than it is in other areas. As a result, coolant in the circulating mechanism housing portion 4 can be supplied concentrated at the cylindrical cells 123 where the amount of heat generated is large.

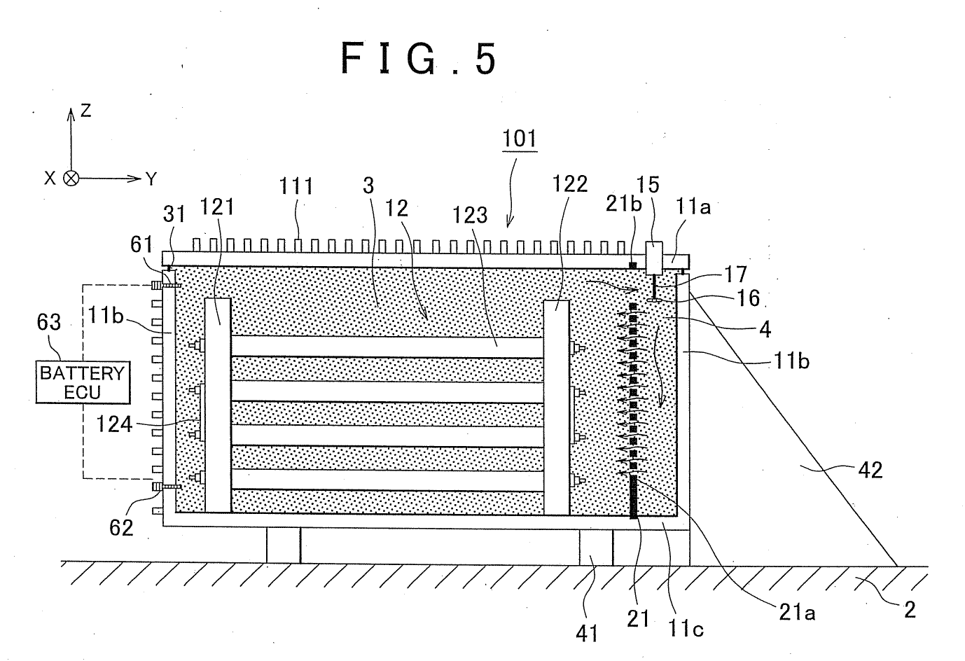

Next, a power supply apparatus according to a third modified example of the first example embodiment, in which the arrangement of power supply apparatus has been modified, will be described with reference to FIG. 5. FIG. 5 is a plan view of a power supply apparatus 101 according to the third modified example of the first example embodiment, which illustrates a modified arrangement of the power supply apparatus.

Parts in this modified example that have the same function as parts in the first example embodiment will be denoted by like reference characters.

A support member 41 that supports the power supply apparatus 101 is interposed between the power supply apparatus 101 and the floor panel 2. That is, the power supply apparatus 101 does not contact the floor panel 2. Incidentally, the assembled battery is fixed to the case lower wall portion 11c by fixing means, not shown.

A heat transmitting plate 42 that serves as a heat transmitting member which contacts the floor panel 2 is mounted to the outer peripheral surface of the case side wall portion 11b. The heat transmitting plate 42 is made of material having high thermal conductivity (e.g., metal material such as iron or copper), just like the battery case 11. Heat exchange takes place between the power supply apparatus 101 and the floor panel 2 via this heat transmitting plate 42. Incidentally, the heat transmitting plate 42 may be mounted to one side portion (i.e., either side portion) of the case side wall portion 11b or both side portions.

In this case, cold air outside the vehicle is transmitted to the coolant via the heat transmitting plate 42 and the case side wall portion 11b so the dividing plate 21 is arranged between the case side wall portion 11b and the assembled battery 12. That is, in FIG. 5, the area to the right of the dividing plate 21 is the circulating mechanism housing portion 4 and the area to the left of the dividing plate 21 is the battery housing portion 3. The same effects as those obtained with the first example embodiment can also be obtained with this structure.

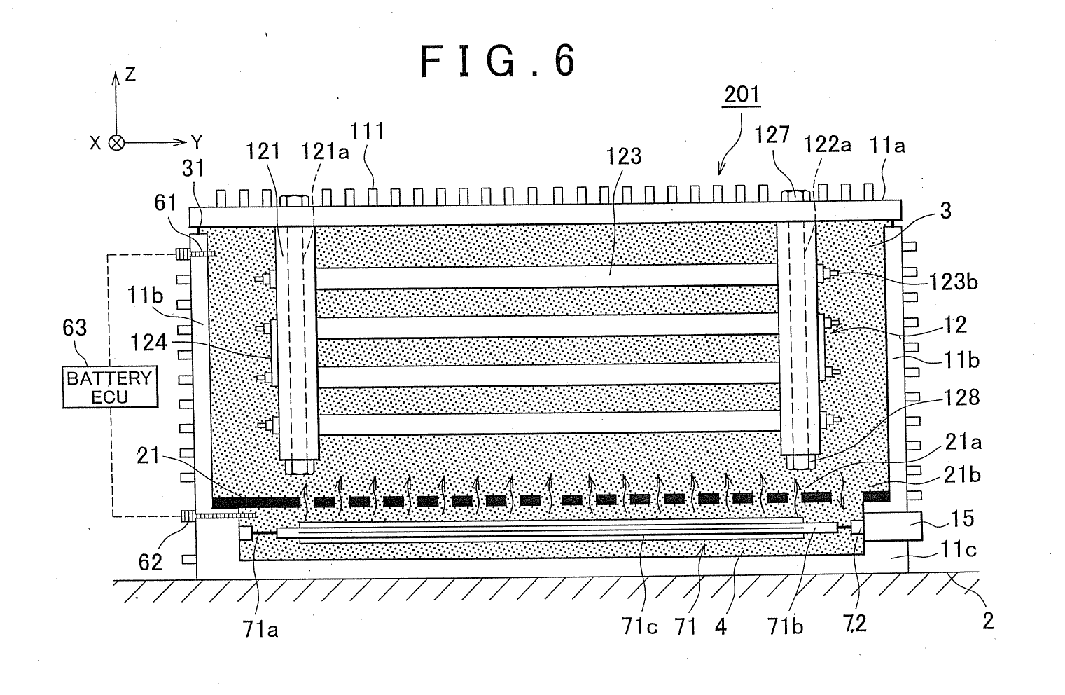

Next, a power supply apparatus according to a fourth modified example of the first example embodiment, in which the circulating means has been modified, will be described with reference to FIG. 6. FIG. 6 is a plan view of a power supply 201 according to the fourth modified example of the first example embodiment, which illustrates a modified example of the circulating means. Parts in this modified example that have the same function as parts in the first example embodiment will be denoted by like reference characters.

A circulating member 71 that has a different structure than the circulating fin 16 is provided in the circulating mechanism housing portion 4. A fin rotating shaft 71a of this circulating member 71 is rotatably supported at both end portions by radial bearing members 72 provided on both sides of the case side wall portion 11b. The fin rotating shaft 71a is rotatably driven from outside the battery case 11 by a magnetic motor 15.

A hollow cylindrical roller member 71b having an inner diameter that is generally the same as the outer diameter of the fin rotating shaft 71a is mounted to the fin rotating shaft 71a. A plurality of circulating fins 71c that extend in the length direction of the roller are formed in the circumferential direction on the outer peripheral surface of the roller member 71b.

When the magnetic motor 15 is driven, the circulating fins 71c rotate around the fin rotating shaft 71a and as they do so, they move coolant from inside the circulating mechanism housing portion 4 through the coolant passage holes 21a and into the battery housing portion 3.

The same effects as those obtained with the first example embodiment can also be obtained with this structure. Incidentally, the circulating means is not limited to the foregoing structure. For example, a pump may also be used.

Also, if the coolant can be forcibly circulated (i.e., forced convention) between the battery housing portion 3 and the circulating mechanism housing portion 4 through the coolant passage holes 21a, circulating means such as the circulating fins 16 or the circulating member 71 or the like may also be arranged inside the battery housing portion 3.

Next, a modified example of the method for driving the motor will be described. In the foregoing embodiments, the circulating fin 16 is made to rotate based on temperature information from the first and second temperature sensors 61 and 62. Alternatively, however, the second temperature sensor 62 may be provided on the body of the vehicle.

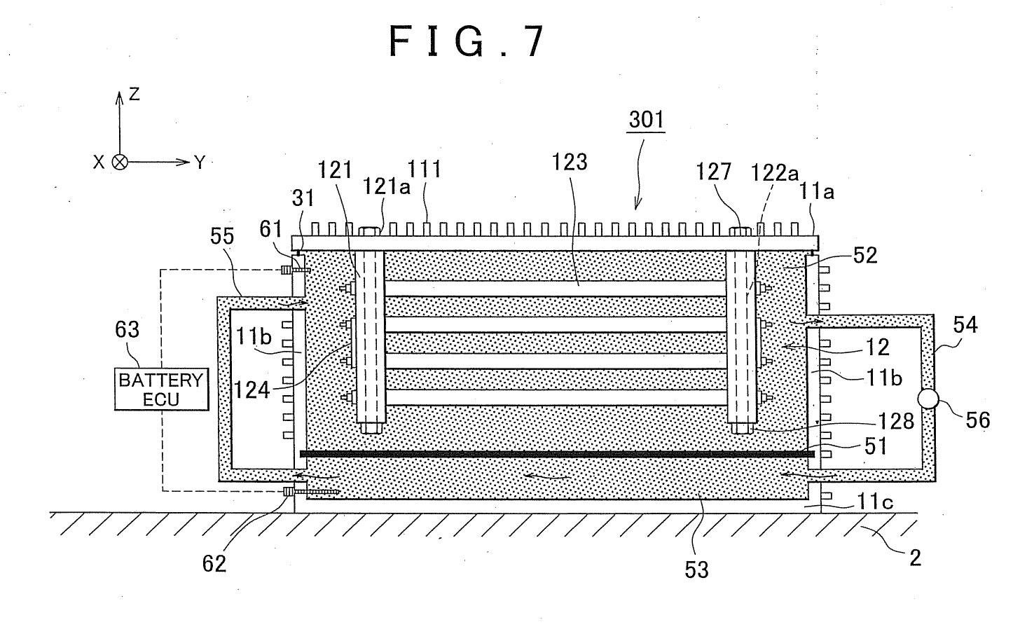

Next, the structure of a power supply 301 according to a second example embodiment of the invention will be described with reference to FIG. 7. Parts in this example embodiment that have the same function as parts in the first example embodiment will be denoted by like reference characters.

The battery case 11 is divided by a dividing plate 51 into a first housing portion 52 that houses the assembled battery 12 and a second housing portion 53 that is positioned on the floor panel 2 side of the first housing portion 52. Unlike the dividing plate in the first example embodiment, open portions corresponding to the coolant passage holes 21a are not formed in the dividing plate 51 of this second example embodiment. As a result, coolant is prohibited from moving between the first and second housing portions 52 and 53 through the dividing plate 51.

The first and second housing portions 52 and 53 through which coolant is able to flow are connected via first and second circulation passages 54 and 55 formed outside of the battery case 11.

A circulating pump 56 for circulating coolant between the first and second housing portions 52 and 53 is provided in the first circulating passage 54. Incidentally, the circulating pump 56 may also be provided in the second circulating passage 55. Also, a radiator for cooling coolant that flows out from the first housing portion 52 may also be arranged in the first circulating passage 54. Further, a value that controls the circulation of coolant to the radiator may also be provided.

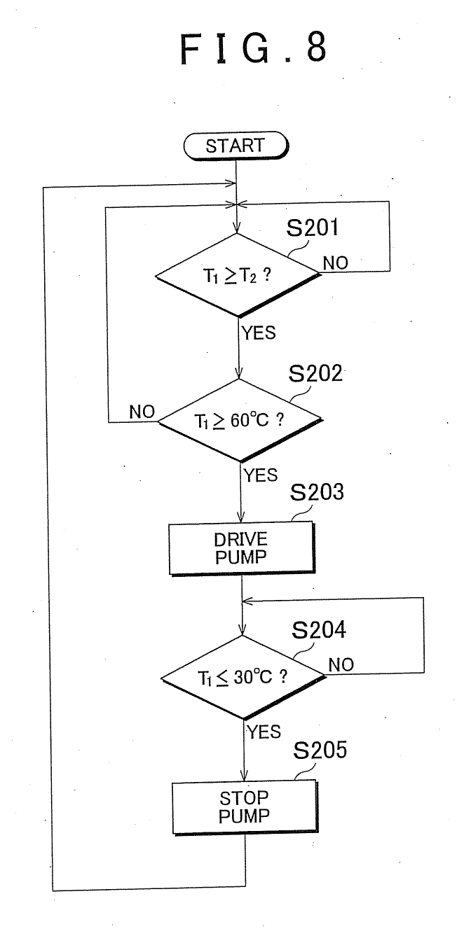

Next, the method for driving the circulating pump 56 will be described with reference to FIGS. 7 and 8. FIG. 8 is a flowchart illustrating a method for driving a circulation pump. Incidentally, the flowchart described below is executed by the battery ECU 63, as it is in the first example embodiment.

First, the battery ECU 63 compares a temperature T1 of the coolant inside the first housing portion 52 with a temperature T2 of the coolant inside the second housing portion 53 based on temperature information output from the first and second temperature sensors 61 and 62 (step S201).

If it is determined that T1 is equal to or greater than T2 (i.e., T1≧T2), the process proceeds on to step S202 where the battery ECU 63 determines whether T1 is equal to or greater than 60° C. (i.e., T1≧60° C.). If it is determined that T1 is equal to or greater than 60° C. (i.e., YES in step S202), the battery ECU 63 drives the circulating pump 56 (step S203).

When the battery ECU 63 drives the circulating pump 56, coolant from within the first housing portion flows into the second housing portion 53 through the first circulating passage 54, as shown by the arrow. At this time, the coolant that has flowed into the second housing portion 53 is cooled by contacting the case lower wall portion 11c. This coolant that has been cooled then flows into the first housing portion 52 through the second circulating passage 52.

As a result, the temperature of the coolant within the first housing portion 52 drops, thereby protecting the assembled battery 12 from degradation.

Also, by circulating the coolant through the first and second circulating passages 54 and 55, the coolant inside the first housing portion 52 is circulated (i.e., agitated) which suppresses variation in the temperature of the coolant. As a result, the life of the assembled battery 12 can be increased.

The reason for making T1≧60° C. a condition for driving the circulating pump 56 is the same as the reason given in the first example embodiment so an explanation will be omitted here.

If it is determined in step S202 that T1 is less than 60° C. (i.e., T1<60° C.), the battery ECU 63 prohibits driving of the circulating pump 56 and the process returns to step S201. If it is determined that T1 is equal to or greater than T2 (i.e., T1≧T2) but less than 60° C. (i.e., T1<60° C.), the temperature of the cooling within the second housing portion 53 may drop excessively from cold air outside the vehicle. If the circulating pump 56 is driven in this case, the temperature of the coolant within the first housing portion 52 may drop even further and sufficient battery output may not be able to be obtained.

Therefore, if it is determined in step S102 that T1 is less than 60° C. (i.e., T1<60° C.), the battery ECU 63 prohibits driving of the circulating pump 56. As a result, the temperature of the assembled battery 12 can be maintained or increased.

When the battery ECU 63 drives the circulating pump 56 in step S203, the battery ECU 63 determines whether T1 is equal to or less than 30° C. (i.e., whether T1≦30° C.), that is, whether the temperature of the coolant in the battery housing portion 3 has dropped to 30° C. or below (step S204).

If it is determined in step S204 that T1 is equal to or less than 30° C. (i.e., T1≦30° C.), the process proceeds on to step S205 where the battery ECU 63 stops the circulating pump 56.

If it is determined in step S204 that T1 is greater than 30° C. (i.e., T1>30° C.), the battery ECU 63 continues to drive the circulating pump 56.

If it is determined in step S201 that T2 is greater than T1 (i.e., T2>T1), i.e., if the temperature of the coolant in the second housing portion 53 is higher than the temperature of the coolant in the first housing portion 52, the battery ECU 63 prohibits driving of the circulating pump 56.

If it is determined that the T2 is greater than T1 (i.e., T2>T1), it means that the temperature of the floor panel 2 is high (which may occur when the vehicle is parked in a high-temperature environment with the engine stopped, for example). Therefore, if coolant from the second circulating portion 53 is circulated into the first housing portion 52 at this time, the temperature may rise and promote degradation of the assembled battery 12.

The same effects as those obtained with the first example embodiment can also be obtained with this second example embodiment. Also, no open portion(s) corresponding to the coolant passage holes 21a in the first example embodiment is/are formed in the dividing plate 51. Therefore, when the circulating operation is prohibited (when the circulating pump 56 is stopped), coolant can be reliably prevented from moving between the first and second housing portions 52 and 53.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

1. A power supply apparatus comprising:
a power supply case housing a power supply body and coolant that cools the power supply body, that contacts a heat transmitting member;
a first housing portion that is within the power supply case and houses the power supply body;
a second housing portion that is within the power supply case and positioned on the heat transmitting member side of the first housing portion;
a dividing plate that allows the coolant to move between the first housing portion and the second housing portion; and
a circulating portion that circulates the coolant between the first housing portion and the second housing portion.

2. The power supply according to claim 1, wherein at least one coolant passage hole through which the coolant passes between the first housing portion and the second housing portion is formed in the dividing plate.

3. (canceled)

4. The power supply apparatus according to claim 1, wherein a gap through which the coolant passes between the first housing portion and the second housing portion is formed in the dividing plate.

5. The power supply apparatus according to claim 1, wherein the circulating portion is provided in the second housing portion.

6. The power supply apparatus according to claim 1, further comprising:
a first temperature detecting portion that detects a temperature of the coolant in the first housing portion;
a second temperature detecting portion that detects a temperature of the coolant in the second housing portion; and
a controlling portion that controls a circulating operation of the circulating portion based on detection results by the first temperature detecting portion and the second temperature detecting portion,
wherein the controlling portion prohibits the circulating operation of the circulating portion when a second detected temperature from the second temperature detecting portion is higher than a first detected temperature from the first temperature detecting portion.

7. The power supply apparatus according to claim 6, wherein the controlling portion operates the circulating portion when the first detected temperature is within a predetermined temperature range.

8. The power supply apparatus according to claim 1, wherein the power supply body is fixed to an upper wall portion of the power supply case, and the dividing plate is arranged below the power supply body.

9. The power supply apparatus according to claim 1, wherein the dividing plate has a thermal conductivity that is lower than the thermal conductivity of the coolant.

10. The power supply apparatus according to claim 1, wherein a plurality of cooling fins are provided on an outer wall surface of the power supply case.

11. The power supply apparatus according to claim 1, wherein the dividing plate is provided parallel to a surface of the power supply case which contacts the heat transmitting member.

12. The power supply apparatus according to claim 1, wherein the heat transmitting member is a floor panel of a vehicle.

13. The power supply apparatus according to claim 1, wherein the circulating means portion is one of a fin and a pump which rotates when driven by a motor.

14. The power supply apparatus according to claim 1, wherein the power supply apparatus is mounted in a vehicle.

15. A power supply apparatus comprising:
a power supply case housing a power supply body and coolant that cools the power supply body, that contacts a heat transmitting member;
a first housing portion that is within the power supply case and houses the power supply body;
a second housing portion that is within the power supply case and positioned on the heat transmitting member side of the first housing portion; and
a circulating passage which is provided outside the power supply case and through which the coolant circulates between the first housing portion and the second housing portion.

16. The power supply apparatus according to claim 15, further comprising:
a dividing plate that isolates the coolant in the first housing portion from the coolant in the second housing portion within the power supply case.

17. The power supply apparatus according to claim 15, further comprising:
a circulating portion that circulates the coolant between the first housing portion and the second housing portion when the temperature of the coolant is equal to or higher than a predetermined temperature.

18. The power supply apparatus according to claim 17, wherein the circulating portion is a pump.

19. The power supply apparatus according to claim 17, wherein the circulating passage is formed in plurality, and the circulating portion is provided in any one of the plurality of circulating passages.

20. The power supply apparatus according to claim 15, wherein the circulating passage further has a radiator.
